(19) United States
(12) Patent Application Publication
(10) Pub. No.: US 2026/0237935 A1
(43) Pub. Date: Aug. 13, 2026

(54) LATCHING SEALED USB CONNECTOR ASSEMBLY

(71) Applicant: Molex, LLC, Lisle, IL (US)

(72) Inventors: Praveen Kumar Chakkarai, Bangalore (IN); Adithya Surendran Jayakumari, Bangalore (IN); Arunraj Ramasamy, Bangalore (IN)

(21) Appl. No.: 19/445,701

(22) Filed: Jan. 12, 2026

(30) Foreign Application Priority Data
Jan. 15, 2025 (IN) 202521003425

(51) Int. Cl. H01R 13/52; H01R 13/432; H01R 13/627; H01R 13/6581; H01R 13/66; H01R 24/28; H01R 24/62

(52) U.S. Cl. CPC H01R 13/5221; H01R 13/432; H01R 13/5202; H01R 13/6272; H01R 13/6581; H01R 13/6658; H01R 24/28; H01R 24/62; H01R 2201/06

(57) ABSTRACT

USB connector assemblies are described. An example USB connector assembly includes a connector housing configured to mate with a corresponding connector receptacle, a USB connector disposed partially within the connector housing, and a first seal disposed around the USB connector, the first seal configured to contact a corresponding sealing surface within the corresponding connector receptacle.

### BACKGROUND

Universal Serial Bus (USB) technology is a standard for connecting many types of devices to computers and other systems. A goal of USB technology is to standardize the connection of peripherals, such as keyboards, mice, and storage devices, making them easy to connect with plug-and-play functionality. Traditional USB connector types (e.g., USB-A, USB-B, mini USB micro USB) have some limitations. For example, these connectors can wear out and often may only be connected in one predetermined orientation, which may lead to connector damage or user frustration.

### BRIEF DESCRIPTION OF THE DRAWINGS

In the drawings, which are not necessarily drawn to scale, like numerals may describe similar components in different views. Some embodiments are illustrated by way of example, and not limitation, in the figures of the accompanying drawings.

FIGS. 1A-1B are technical drawings of an assembled USB connector assembly, according to an embodiment.

FIG. 2 is a technical drawing of a separated USB connector assembly, according to an embodiment.

FIG. 3 is a technical drawing of a first portion of a USB connector assembly, according to an embodiment.

FIG. 4 is a technical drawing of a second portion of a USB connector assembly, according to an embodiment.

FIG. 5 is a technical drawing of a third portion of a USB connector assembly 500, according to an embodiment.

FIGS. 6A-6B are technical diagrams of a cross-sections of the USB connector assembly, according to an embodiment.

FIG. 7 is a technical diagram of a first latching connector assembly, according to an embodiment.

FIG. 8 is a technical diagram of a second latching connector assembly, according to an embodiment.

FIG. 9 is a technical diagram of a partial cross-section of the USB connector, according to an embodiment.

FIG. 10 is a technical diagram of a first releasable USB connector assembly, according to an embodiment.

FIG. 11 is a technical diagram of second releasable USB connector assembly, according to an embodiment.

FIG. 12 is a technical diagram of a partially formed USB connector assembly, according to an embodiment.

FIG. 13 is a technical diagram of a flattened USB connector assembly, according to an embodiment.

FIG. 14 is a technical diagram of a first assembled USB shield, according to an embodiment.

FIG. 15 is a technical diagram of a second assembled USB shield, according to an embodiment.

### DETAILED DESCRIPTION

Technical solutions are described herein to address technical problems facing USB connectors. The improved USB connector assembly described herein provides a small, reversible plug and receptacle that addresses many of the limitations of earlier connectors. The USB connector supports higher data transfer rates and increased power delivery, and may carry non-USB data such as transmission of video signals (e.g., High-Definition Multimedia Interface (HDMI), DisplayPort). The USB connector assembly described herein may include a USB Type-C connector that provides more pins than earlier USB versions, allowing for improved performance and greater power delivery. The design of the USB connector assembly and its internal paddle card provides improved data transfer, power delivery, and video output.

The design of the USB connector assembly provides various improvements. The USB connector assembly includes a first cable bundle for power wires and a second cable bundle for high-speed differential communication cable (e.g., wire) pairs, each of which may include a cable shield to provide improved radio frequency (RF) shielding. This provides advantages over unshielded solutions that did not address electromagnetic interference (EMI), radio frequency interference (RFI).

The USB connector assembly includes a dual exit housing, a sealed rear strain relief, and a connector position assurance latch. The housing, strain relief, and connector position assurance latch ensure secure connections with a corresponding connector receptacle, which provides improved mechanical stability and reduces or minimizes the likelihood that the connector is dislodged due to vibrations or physical stress. The housing may provide a friction fit when the housing is engaged with the corresponding connector receptacle. The connector position assurance latch may operate by sliding toward the USB connector when engaged, thereby securing the connection and preventing separation due to vibration or physical stress. In an example, the connector position assurance may include a ramped surface with a tooth to engage with a corresponding latch receptacle on a housing receptacle. When engaged, the connector position assurance latch prevents the separation of the dual exit housing from the receptacle. The connector position assurance latch effectively locks the connection in place, providing an additional layer of security beyond the standard friction fit.

The USB connector assembly further provides improved environmental sealing through a sealed rear strain relief and multiple internal seals. The sealing may include a first seal (e.g., a gasket) and a second seal that is inserted after a seal retainer is placed into the dual exit housing. These seals provide improved protection for internal components from contaminants such as dust, moisture, and other contaminants that might otherwise pose risks to the integrity and longevity of the connectors.

The cables within the USB connector assembly provide both power delivery and high-speed data transmission functionalities through distinct cable bundles. In an example, a first cable bundle includes power wires, which may be used to deliver electrical power to connected devices. In an example, the second cable bundle includes high-speed differential pairs, such as transmit (Tx) and receive (Rx) lines for differential data transmission. One or both of the cable bundles may be shielded to improve data transmission speeds and reduce or minimize data errors, which may be used to provide improved throughput for USB 3.x, USB 4, or other USB communication standards. The cables may include a sheath, which provides improved mechanical stability for both the first and second cable bundles. This sheath may be used to improve mechanical stability, such as by enabling an internal clamp to secure the cables in a fixed position relative to the USB connector, reducing or minimizing USB connector movement. The cable shield may be conductively coupled to a ground contact on a paddle card inside the USB connector assembly, which further improves the effectiveness of the shield in mitigating EMI and RFI.

In the following description, for purposes of explanation, numerous specific details are set forth to provide a thorough understanding of some example embodiments. It will be evident, however, to one skilled in the art that the present disclosure may be practiced without these specific details.

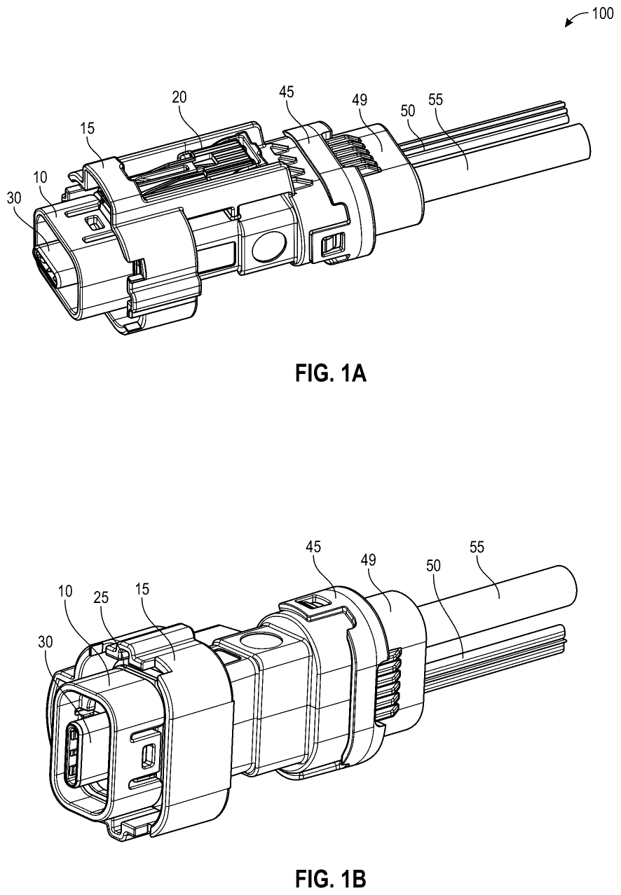

FIG. 1A is a technical drawing of an assembled USB connector assembly 100, according to an embodiment. The assembled USB connector assembly 100 includes various features that provide improved electrical and mechanical performance. The assembled USB connector assembly 100 includes a dual exit housing 15, which includes and secures various other components.

The dual exit housing 15 is configured to engage with a corresponding connector receptacle. When engaged, an inner surface of the dual exit housing 15 may provide a friction fit with a surface of the connector receptacle. When the assembled USB connector assembly 100 is engaged with a corresponding connector receptacle, the connector position assurance latch 20 is configured to prevent accidental disconnection of the assembled USB connector assembly 100. The connector position assurance latch 20 may slide away from USB connector 30 when disconnected, and may slide (e.g., translate) along the dual exit housing 15 toward USB connector 30 into a latched position when the USB connector 30 is connected, securing the dual exit housing 15 to the corresponding connector receptacle. The connector position assurance latch 20 may include a curved or substantially right-angle (e.g., substantially 90°) portion to engage with a corresponding latch engagement feature.

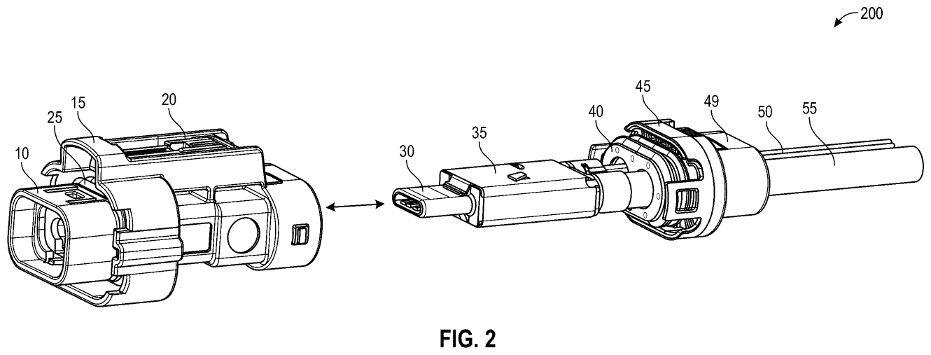

The dual exit housing 15 may secure a seal retainer 10, which may be used to secure a seal (e.g., first seal 25 shown in FIG. 2) to provide improved environmental sealing. The seal retainer 10 may be used to secure the USB connector 30, which provides a USB-C interface through which the device connects with other USB-C compatible devices. When the dual exit housing 15 is engaged with a corresponding connector receptacle, an outer surface of the seal retainer 10 may provide a friction fit with a surface of the connector receptacle. The USB connector 30 includes pins for electrical connection, and is designed to support USB-C transmission standards.

A rear cover 45 and strain relief molding 49 combine to form a sealed rear strain relief, which may be connected to the dual exit housing 15. The first cable bundle 50 and second cable bundle 55 may extend from the dual exit housing 15 through the rear cover 45 and strain relief molding 49. In an example, the assembled USB connector assembly 100 may be assembled by threading the relief molding 49 onto the first cable bundle 50 and second cable bundle 55, then threading the rear cover 45 over the relief molding 49 to secure the relief molding 49 to the dual exit housing 15. The rear cover 45 and strain relief molding 49 provide the sealed rear strain relief, which provides an environmental seal and help prevent the first cable bundle 50 and second cable bundle 55 from being removed from the dual exit housing 15, thereby reducing strain on the connections.

In an example, the first cable bundle 50 includes power wires for the transmission of electrical power through the connector. In an example, the second cable bundle 55 includes high-speed differential pairs used for differential data transmission. While FIG. 1A shows second cable bundle 55 as including a surrounding shield or sheath, either or both of the first cable bundle 50 and second cable bundle 55 may be shielded to improve data transmission speeds and reduce errors. While FIG. 1A shows the first cable bundle 50 and the second cable bundle 55, three or more cable bundles may be used, such as to separate a power delivery cable bundle, a data transmission cable bundle, a control communication cable bundle, a legacy USB data cable bundle, or other cable bundles.

While FIG. 1A shows a first straight exit, where first cable bundle 50 and second cable bundle 55 exit substantially coaxially with the USB connector 30, other orientations may be used. In an example, the rear cover 45, strain relief molding 49, first cable bundle 50, and second cable bundle 55 may be configured to be offset from a coaxial configuration, such as at 45°, 90°, 135°, or other angles relative to a coaxial configuration. Similarly, the rear cover 45, strain relief molding 49, first cable bundle 50, and second cable bundle 55 may be configured to be offset from a coaxial configuration in the direction of the connector position assurance latch 20 (e.g., upward), toward or away from the viewer of FIG. 1A, or other offset directions.

FIG. 1B is a technical drawing of a second view of the assembled USB connector assembly 100, according to an embodiment. The second view of the assembled USB connector assembly 100 shown in FIG. 1B is similar to the first view shown in FIG. 1A, though each is rotated 90° along the cable axis with respect to the other.

As shown in the second view of the assembled USB connector assembly 100, the USB connector 30 may be encircled by the seal retainer 10.

The first seal 25 may be disposed between the seal retainer 10 and a sealing surface within the dual exit housing 15, may encircle an inner portion of the dual exit housing 15, and may be secured in place by the seal retainer 10. The rear cover 45 and strain relief molding 49 may be secured to the dual exit housing 15. The first cable bundle 50 and the second cable bundle 55 may extend from within the dual exit housing 15 through the rear cover 45 and strain relief molding 49.

FIG. 2 is a technical drawing of a separated USB connector assembly 200, according to an embodiment. The USB connector assembly 200 shows features similar to the assembled USB connector assembly 100, but separates the dual exit housing 15 from the rear cover 45 and strain relief molding 49.

As shown in FIG. 2, the dual exit housing 15 serves as the main structural component. The dual exit housing 15 is designed to engage with a corresponding connector receptacle. The dual exit housing 15 includes the connector position assurance latch 20 designed to prevent accidental disconnection of the dual exit housing 15 from its corresponding connector receptacle. After the dual exit housing 15 is engaged with a corresponding connector receptacle, the connector position assurance latch 20 may be slid into a latching position to engage with a corresponding latch receptacle on the corresponding connector receptacle.

The separated USB connector assembly 200 in FIG. 2 shows the dual exit housing 15 separated from the USB connector 30. The USB connector 30 includes pins (e.g., electrical contacts) for electrical connection, and is designed to support USB-C transmission standards. A portion of the USB connector 30 may be surrounded by an RF shield 35. The RF shield 35 provides RF shielding for the USB connector 30 and for internal circuitry. The RF shield 35 also provides mechanical stability by retaining (e.g., clamping) the first cable bundle 50 and second cable bundle 55 in a fixed position relative to the USB connector 30.

A second seal 40 (e.g., a gasket) may be disposed around the first cable bundle 50 and the second cable bundle 55. The first seal 25 and the second seal 40 provides environmental protection, including protecting the internal components from external contaminants such as moisture, dust, and other particles. While the USB connector assembly 300 is shown and described with the first seal 25 and the second seal 40 included, the USB connector assembly 300 may be provided without one or both of the first seal 25 or the second seal 40. While the USB connector assembly 300 with seals may provide improved protection for internal components against external contaminants, the USB connector assembly 300 without seals may provide reduced complexity and reduced costs associated with assembly and production.

The rear cover 45 and strain relief molding 49 may be configured to latch to the dual exit housing 15, and may be used to secure the second seal 40 between the dual exit housing 15 and the rear cover 45 and strain relief molding 49. The rear cover 45 and strain relief molding 49 also prevents the first cable bundle 50 and the second cable bundle 55 from being removed from the dual exit housing 15, thereby reducing strain on the connections within the dual exit housing 15.

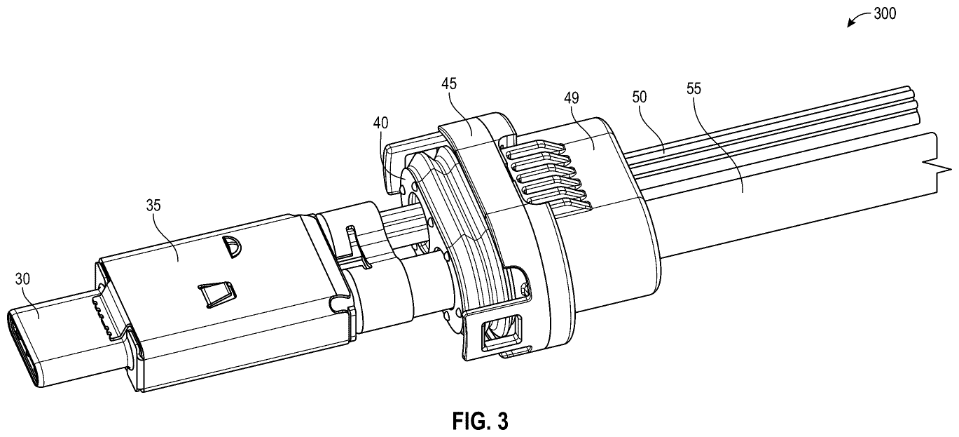

FIG. 3 is a technical drawing of a first portion of a USB connector assembly 300, according to an embodiment. The USB connector assembly 300 shows another view of the rightmost portion of the separated USB connector assembly 200 shown in FIG. 2. A portion of the USB connector 30 may be surrounded by the RF shield 35, which provides RF shielding for the USB connector 30 and for internal circuitry. A portion of the RF shield 35 between the USB connector 30 and the first cable bundle 50 and second cable bundle 55 may be crimped around a portion of the first cable bundle 50 and second cable bundle 55 to secure the cables in a fixed position relative to the USB connector 30. The second seal 40 may be disposed around the first cable bundle 50 and the second cable bundle 55. The rear cover 45 and strain relief molding 49 may be used to secure the second seal 40 within the dual exit housing 15.

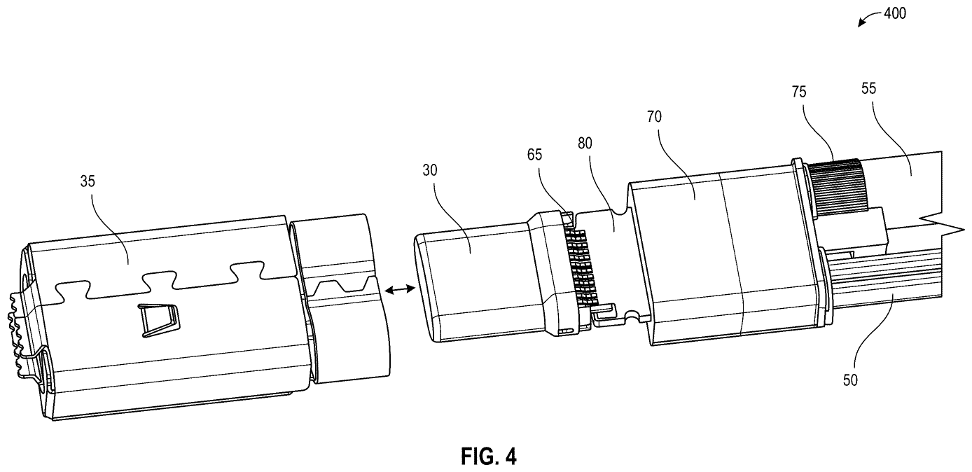

FIG. 4 is a technical drawing of a second portion of a USB connector assembly 400, according to an embodiment. The USB connector assembly 400 shows another view of the USB connector 30 and RF shield 35 shown in FIG. 3, where FIG. 4 shows the RF shield 35 separated from the USB connector 30.

The RF shield 35 provides RF shielding for the cables and internal circuitry. The internal circuitry may include pins 65 connecting the USB connector 30 to a paddle card 80. An encapsulant mold 70 may surround a portion of the paddle card 80 and connections between the paddle card 80 and the first cable bundle 50 and second cable bundle 55. The encapsulant mold 70 and the RF shield 35 may provide mechanical stability by retaining the first cable bundle 50 and second cable bundle 55 in a fixed position relative to the USB connector 30.

The second cable bundle 55 may be surrounded by a shielded cable jacket 75. The shielded cable jacket 75 may provide a flexible conductive enclosure (e.g., metal braid, foil wrap) that surrounds the cables to prevent electromagnetic interference and provide structural support. The shielded cable jacket 75 may be surrounded by an external cable sheath to provide additional mechanical protection for the shielded cable jacket 75 and the cables within the second cable bundle 55.

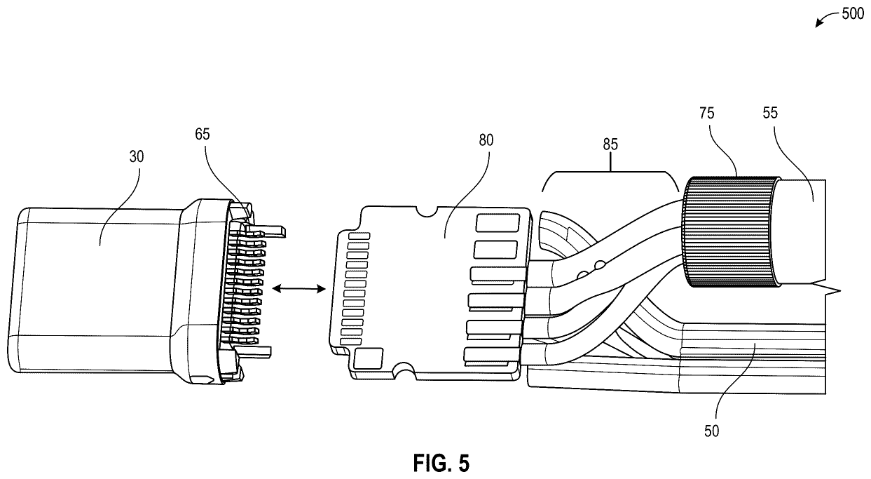

FIG. 5 is a technical drawing of a third portion of a USB connector assembly 500, according to an embodiment. The USB connector assembly 500 shown in FIG. 5 includes the USB connector 30 and the pins 65 separated from the paddle card 80. The pins 65 may include a plurality of surface mount leads configured to be soldered to a corresponding plurality of surface mount pin contact pads on the paddle card 80. Similarly, the first cable bundle 50 and second cable bundle 55 may each include a plurality of cables 85 configured to be soldered to a corresponding plurality of surface mount wire contact pads on the paddle card 80. The soldering of the cables 85 and pins 65 to the paddle card 80 provides conductive paths for communication and power, and provides mechanical stability between the USB connector 30, the paddle card 80, and the first cable bundle 50 and second cable bundle 55.

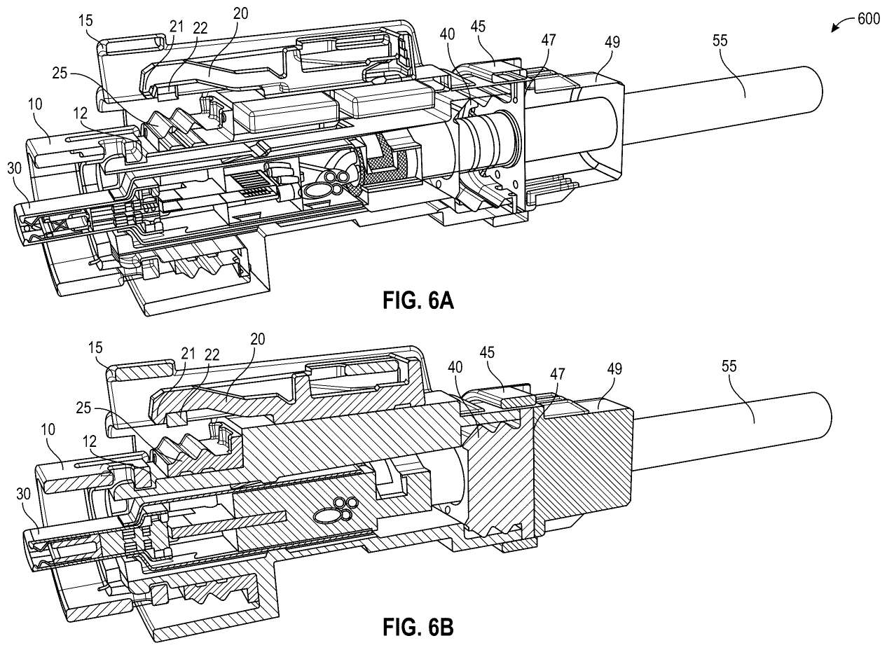

FIGS. 6A-6B are technical diagrams of cross-sections of the USB connector 600, according to an embodiment. FIG. 6A shows a first cross-section that displays all internal components that would be visible if the USB connector 600 were cut to show only the second cable bundle 55 side of the USB connector 600. FIG. 6B shows a second cross-section that includes the same side of the USB connector 600, but shows each of the selected components using cross-hatching. The cross-hatching shown in FIG. 6B is not intended to indicate a type of material to be used (e.g., rubber, plastic), but is used to identify different components. The materials used may include plastic materials designed to withstand harsh conditions such as extreme temperatures, chemicals, and physical stress, such as thermoplastics (e.g., polycarbonate, polyvinyl chloride), engineering plastics (e.g., polyamide (nylon), acrylonitrile butadiene styrene), and high-performance polymers (e.g., polyetherimide).

The dual exit housing 15 serves as the main structural component that houses various parts of the USB connector 600. The connector position assurance latch 20 may be disposed within a portion of the dual exit housing 15. The connector position assurance latch 20 may slide into a locked position after the dual exit housing 15 is connected to a corresponding connector receptacle, securing the dual exit housing 15 to the corresponding connector receptacle. The connector position assurance latch 20 may include a curved or substantially right-angle portion 21 to engage with a corresponding latch engagement feature 22.

A first seal 25 may be placed within the dual exit housing 15. The first seal 25 may be configured to contact with an internal portion of the corresponding connector receptacle to provide environmental protection. In an example, the first seal 25 may include one or more deformable serrated surfaces (e.g., ridges) to improve contact with the internal portion of the corresponding connector receptacle and provide improved environmental protection. In the example depicted in FIG. 6B, two such ridges are illustrated.

The seal retainer 10 may be secured to an internal portion of the dual exit housing 15 to retain the first seal 25 in place within the dual exit housing 15. In an example assembly process, the first seal 25 may be inserted within the dual exit housing 15, and the seal retainer 10 may be inserted after the first seal 25. The seal retainer 10 may include one or more surfaces 12 in proximity to the first seal 25 to prevent the first seal 25 from being removed from the dual exit housing 15, such as due to vibration or during removal of the dual exit housing 15 from the corresponding connector receptacle.

A second seal 40 may be inserted into the dual exit housing 15. The second seal 40 provides further environmental protection, and may include one or more deformable serrated surfaces to improve contact with the internal portion of the dual exit housing 15 to provide improved environmental protection. The strain relief molding 49 may include one or more surfaces 47 to secure the second seal 40 within the dual exit housing 15. The rear cover 45 and strain relief molding 49 provide further environmental sealing and help prevent the first cable bundle 50 from being removed from the dual exit housing 15.

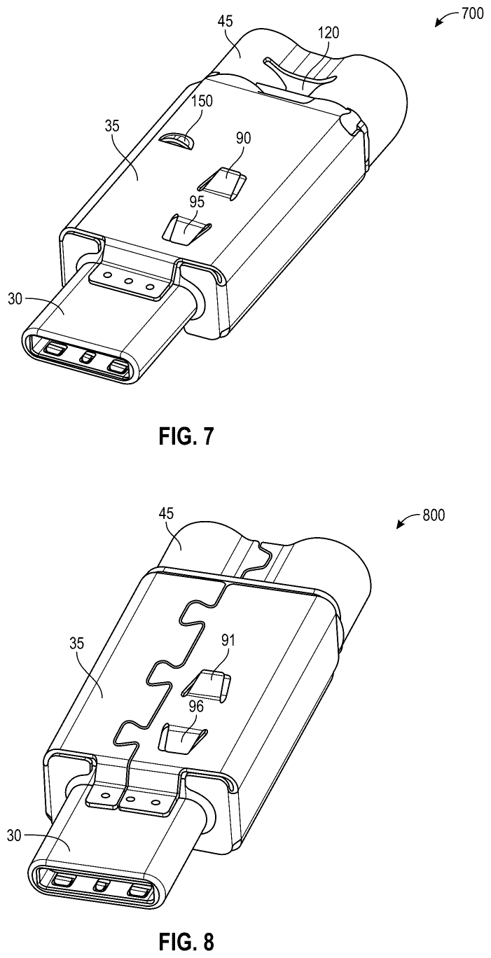

FIG. 7 is a technical diagram of a first latching connector assembly 700, according to an embodiment. The first latching connector assembly 700 includes a USB connector 30. The USB connector 30 may be designed to support USB-C connections and transmission standards. The first latching connector assembly 700 includes an RF shield 35 that surrounds a portion of the USB connector 30, providing mechanical stability and RF shielding for the USB connector 30.

The first latching connector assembly 700 includes a detent 150. The detent 150 may include a raised portion of an outer surface of the RF shield 35. The detent 150 may be formed by a partial cut into an outer surface of the RF shield 35 and deformation of the surface, such as the raised semicircular portion shown in FIG. 7. The detent 150 may be used to prevent over-insertion of the connector, such as by providing a mechanical stop when the RF shield 35 is inserted into the dual exit housing 15.

The first latching connector assembly 700 includes a first lancing feature 90 and a second lancing feature 95. Each of the first lancing feature 90 and the second lancing feature 95 may be formed by partial cuts into the outer surface of the RF shield 35 and deformation of the cut portion to create tabs or protrusions. In various embodiments, each of the first lancing feature 90 and the second lancing feature 95 may be formed using a substantially flat tab, using a curved tab, or another shaped tab. Each of the first lancing feature 90 and the second lancing feature 95 may be used to provide a latching mechanism. For example, the first lancing feature 90 may be used to retain the RF shield 35 within the dual exit housing 15. Similarly, the second lancing feature 95 may be used to secure the USB connector 30 within the RF shield 35. In various embodiments, each of the first lancing feature 90 and the second lancing feature 95 may be formed on a first side of the RF shield 35 (e.g., as shown in FIG. 7), on a second side of the RF shield 35 (e.g., as shown in FIG. 8), maybe formed on separate sides (e.g., first lancing feature 90 on a first side and second lancing feature 95 on a second side), or a combination thereof. In an example, the RF shield 35 may be formed from a high durability alloy to improve the ability for each of first lancing feature 90 and second lancing feature 95 to improve the durability of the latching operations.

The first latching connector assembly 700 includes a rear cover 45 and strain relief molding 49. The rear cover 45 and strain relief molding 49 may be crimped onto first cable bundle 50 and second cable bundle 55, such as to prevent the cable bundles from being removed and to provide strain relief for various internal connections. The rear cover 45 and strain relief molding 49 may include an I-shaped cutout 120, where the I-shaped cutout 120 forms retention tabs that may be crimped onto a cable to further improve cable and braid retention.

FIG. 8 is a technical diagram of a second latching connector assembly 800, according to an embodiment. In an example, the second latching connector assembly 800 shown in FIG. 8 may represent a side opposite from (e.g., the bottom of) the first latching connector assembly 700 shown in FIG. 7. Similar to first latching connector assembly 700, the second latching connector assembly 800 includes a USB connector 30, an RF shield 35 disposed around the USB connector 30, and a rear cover 45 and strain relief molding 49 to provide improved mechanical retention of USB cables.

The second latching connector assembly 800 includes a third lancing feature 91 and a fourth lancing feature 96, which may be used to provide a latching mechanism. In various embodiments, each of the third lancing feature 91 and the fourth lancing feature 96 may be formed using a substantially flat tab, using a curved tab, or another shaped tab. The third lancing feature 91 and the fourth lancing feature 96 shown in second latching connector assembly 800 may be used instead of or in conjunction with the first lancing feature 90 and the second lancing feature 95 shown in the first latching connector assembly 700. In various embodiments, each of the third lancing feature 91 and the fourth lancing feature 96 may be formed on a first side of RF shield 35 (e.g., as shown in FIG. 7), on a second side of RF shield 35 (e.g., as shown in FIG. 8), maybe formed on separate sides, or a combination thereof. For example, both the first lancing feature 90 and the third lancing feature 91 may be used to retain the RF shield 35 within the dual exit housing 15.

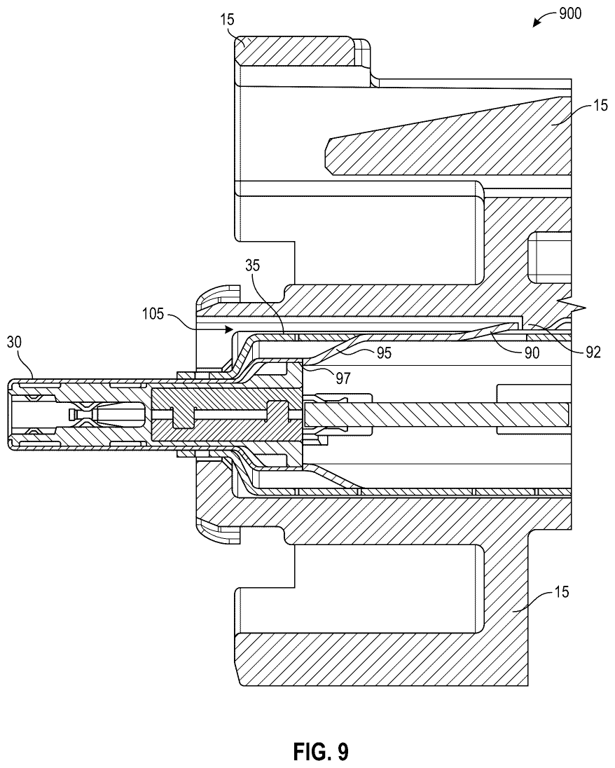

FIG. 9 is a technical diagram of a partial cross-section of the USB connector 900, according to an embodiment. Various contiguous components of USB connector 900 shown in FIG. 9 are identified using cross-hatching. The cross-hatching shown in FIG. 9 is not intended to indicate a type of material to be used (e.g., rubber, plastic), but is used to identify different components, such as the dual exit housing 15 shown in FIG. 9.

The USB connector 900 includes USB connector 30, which may be designed to support USB-C transmission standards. An RF shield 35 surrounds a portion of the USB connector 30, providing RF shielding for the USB connector 30 and internal circuitry. Both the USB connector 30 and the RF shield 35 may be inserted into and retained within the dual exit housing 15.

The first lancing feature 90 and the second lancing feature 95 are configured to function as latches for securing one or more components. For example, during insertion of the RF shield 35 into the dual exit housing 15, the first lancing feature 90 may temporarily deflect to align substantially coplanar with an outer surface of the RF shield 35. Upon full insertion, the first lancing feature 90 may return to a non-coplanar position, engaging a corresponding first inner latching surface 92 within the dual exit housing 15 to form a mechanical interference tab. This mechanical interference tab may be used to secure the RF shield 35 within the dual exit housing 15.

In another example, during insertion of the USB connector 30 into the RF shield 35, the second lancing feature 95 may temporarily deflect to align substantially coplanar with an outer surface of the RF shield 35. Upon full insertion, the second lancing feature 95 may return to a non-coplanar position, engaging a corresponding second inner latching surface 97 within the RF shield 35 to form a mechanical interference latch. This mechanical interference latch may be used to secure the USB connector 30 within the RF shield 35.

The USB connector 900 includes a release tool slot 105. The release tool slot 105 provides an aperture into which a release tool may be inserted. For example, a release tool may be inserted into release tool slot 105 to deflect first lancing feature 90, such as to release the RF shield 35 from dual exit housing 15.

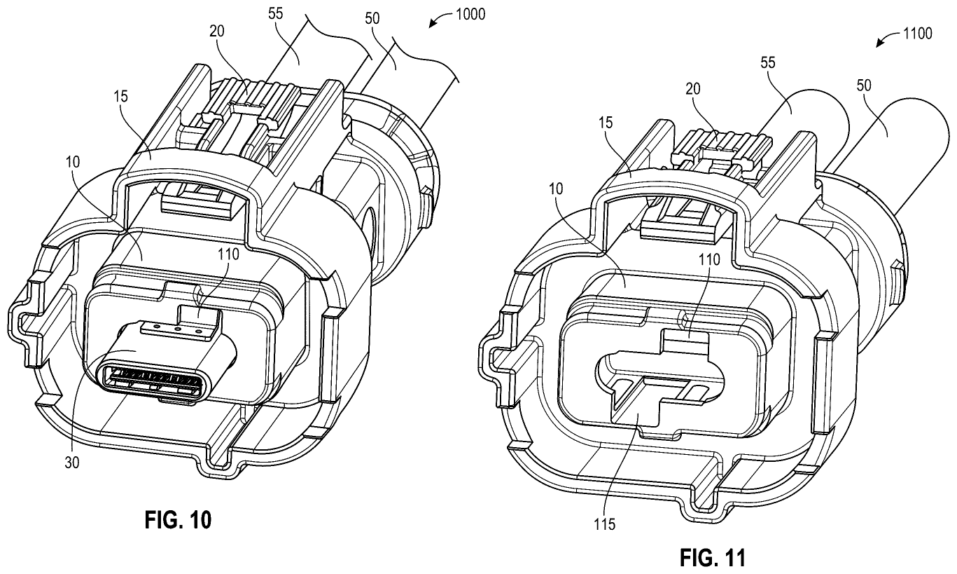

FIG. 10 is a technical diagram of a first releasable USB connector assembly 1000, according to an embodiment. The releasable USB connector assembly 1000 includes a dual exit housing 15. The dual exit housing 15 may be designed to engage with a corresponding connector receptacle, such as by providing a friction fit when engaged. The dual exit housing 15 may include a seal retainer 10 secured to an internal portion of the dual exit housing 15, such as to retain a first seal 25 in place. A USB connector 30 may be disposed within the seal retainer 10, where the USB connector 30 may be designed to support USB-C transmission standards.

The first releasable USB connector assembly 1000 may include a connector position assurance latch 20. The connector position assurance latch 20 may be disposed on the dual exit housing 15. The connector position assurance latch 20 may be configured to prevent accidental disconnection when engaged with a corresponding connector receptacle by sliding into a latching position to engage with a corresponding latch receptacle.

The first releasable USB connector assembly 1000 may include a first cable bundle 50 and a second cable bundle 55. The first cable bundle 50 may include power wires for the transmission of electrical power through the USB connector 30, while the second cable bundle 55 may include high-speed differential pairs used for differential data transmission. The second cable bundle 55 may include a shielded cable jacket to provide improved data transmission speeds and reduce errors.

The first releasable USB connector assembly 1000 includes a first release tool housing aperture 110 into which a release tool may be inserted. The release tool may be inserted into assembled USB connector assembly 100 to deflect a latching mechanism (e.g., lancing feature 90) to release RF shield 35 from dual exit housing 15. The first release tool housing aperture 110 enables controlled disengagement of the RF shield 35 from the dual exit housing 15 when needed.

FIG. 11 is a technical diagram of second releasable USB connector assembly 1100, according to an embodiment. Similar to the first releasable USB connector assembly 1000, the second releasable USB connector assembly 1100 includes a dual exit housing 15, a seal retainer 10 secured to an internal portion of the dual exit housing 15, and USB connector 30 disposed within the seal retainer 10. The second releasable USB connector assembly 1100 also includes a connector position assurance latch 20 disposed on the dual exit housing 15 to prevent accidental disconnection, and a first cable bundle 50 and a second cable bundle 55 to provide power and differential data transmission.

The second releasable USB connector assembly 1100 includes a first release tool housing aperture 110 and a second release tool housing aperture 115. The first release tool housing aperture 110 and the second release tool housing aperture 115 may be configured to receive one or more release tools, such as a two-pronged release tool to be inserted simultaneously into both first release tool housing aperture 110 and second release tool housing aperture 115. The one or more release tools may be inserted to deflect one or more latching mechanisms (e.g., lancing feature 90, third lancing feature 91) to release the RF shield 35 from dual exit housing 15. The first release tool housing aperture 110 and the second release tool housing aperture 115 enables controlled disengagement of the RF shield 35 from the dual exit housing 15 when needed.

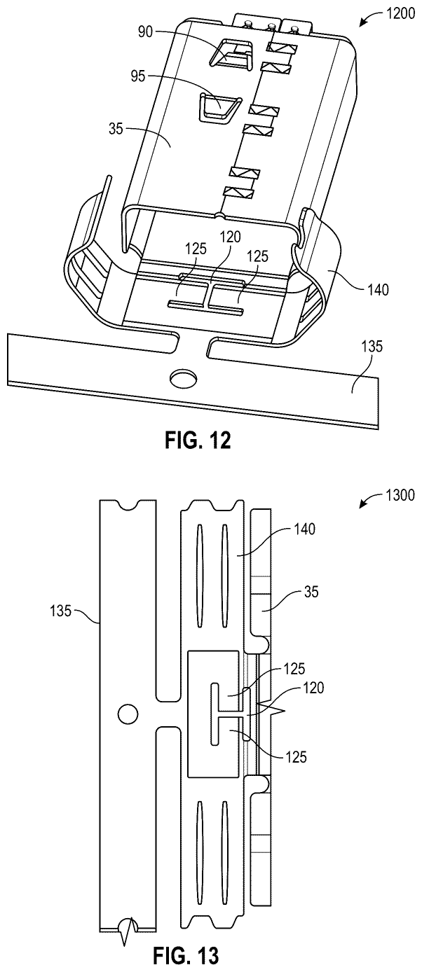

FIG. 12 is a technical diagram of a partially formed USB connector assembly 1200, according to an embodiment. The partially formed USB connector assembly 1200 includes a partially formed RF shield 35 that surrounds a portion of a USB connector and provides RF shielding for the USB connector and internal circuitry. The partially formed USB connector assembly 1200 may include a first lancing feature 90 and a second lancing feature 95, which may be used to provide a mechanical interference mechanism to secure the RF shield 35 within a dual exit housing 15.

The partially formed USB connector assembly 1200 includes a dual wing crimp 140 that may be wrapped and crimped around one or more cables for cable and braid retention. The dual wing crimp 140 includes an I-shaped cutout 120 that forms retention tabs 125. When dual wing crimp 140 is crimped onto a cable, the retention tabs 125 are crimped to further improve cable and braid retention. The I-shaped cutout 120 may include a secondary crimp 135, where the secondary crimp 135 may be wrapped and crimped around the cable for cable retention, providing an additional cable and braid retention.

FIG. 13 is a technical diagram of a flattened USB connector assembly 1300, according to an embodiment. The flattened USB connector assembly 1300 includes an example of a flattened (e.g., pre-crimped) form of the partially formed USB connector assembly 1200, such as the bottom portion of the partially formed USB connector assembly 1200 shown in FIG. 12.

The flattened USB connector assembly 1300 includes a flattened form of the RF shield 35, where the RF shield 35 may be used to surround a portion of a USB connector and provide RF shielding for the USB connector and internal circuitry.

The partially formed USB connector assembly 1200 includes a dual wing crimp 140 that may be wrapped and crimped around one or more cables for cable and braid retention. The dual wing crimp 140 includes an I-shaped cutout 120 that forms retention tabs 125. When dual wing crimp 140 is crimped onto a cable, the retention tabs 125 are crimped to further improve cable and braid retention. The I-shaped cutout 120 may include a secondary crimp 135, where the secondary crimp 135 may be wrapped and crimped around the cable for cable retention, providing an additional cable and braid retention.

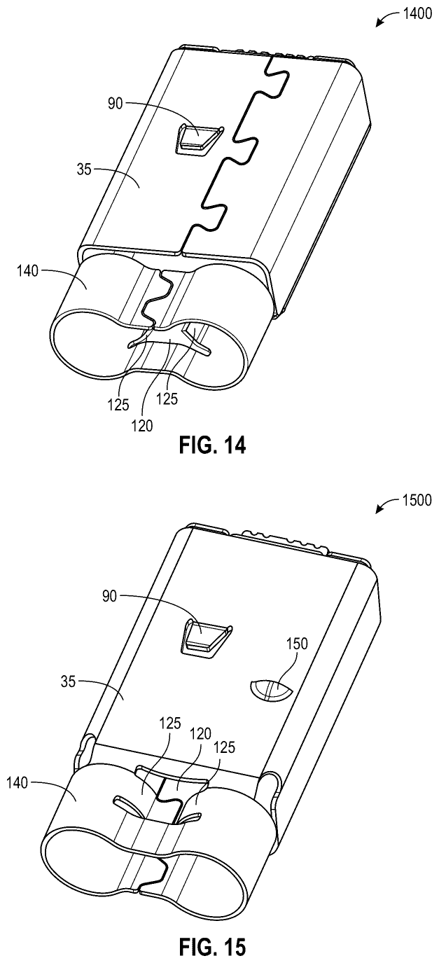

FIG. 14 is a technical diagram of a first assembled USB shield 1400, according to an embodiment. The first assembled USB shield 1400 includes an RF shield 35 that provides RF shielding for the USB connector and internal circuitry. The RF shield 35 includes a first lancing feature 90 that may be formed by partial cuts into the outer surface of the RF shield 35 and deformation of the cut portion to create tabs or protrusions. The first lancing feature 90 may be used to provide a latching mechanism to secure the RF shield 35 within a dual exit housing 15.

The first assembled USB shield 1400 includes a dual wing crimp 140 that may be wrapped and crimped around one or more cables for cable and braid retention. The dual wing crimp 140 includes an I-shaped cutout 120 that forms retention tabs 125. When dual wing crimp 140 is crimped onto a cable, the retention tabs 125 are crimped to further improve cable and braid retention.

FIG. 15 is a technical diagram of a second assembled USB shield 1500, according to an embodiment. The second assembled USB shield 1500 includes an RF shield 35 that provides RF shielding for the USB connector and internal circuitry. The RF shield 35 includes a first lancing feature 90 that may be formed by partial cuts into the outer surface of the RF shield 35 and deformation of the cut portion to create tabs or protrusions. The first lancing feature 90 may be used to provide a latching mechanism to secure the RF shield 35 within a dual exit housing 15.

The second assembled USB shield 1500 includes a detent 150 that may include a raised portion of an outer surface of the RF shield 35. The detent 150 may be formed by a partial cut into an outer surface of the RF shield 35 and deformation of the surface. The detent 150 may be used to prevent over-insertion of the connector, such as by providing a mechanical stop when the RF shield 35 is inserted into the dual exit housing 15.

The second assembled USB shield 1500 includes a dual wing crimp 140 that may be wrapped and crimped around one or more cables for cable and braid retention. The dual wing crimp 140 includes an I-shaped cutout 120 that forms retention tabs 125. When dual wing crimp 140 is crimped onto a cable, the retention tabs 125 are crimped to further improve cable and braid retention.

The apparatuses and methods described above may include or be included in high-speed computers, communication and signal processing circuitry, single-processor module or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

In the detailed description and the claims, a list of items joined by the term “one of” may mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A may include a single element or multiple elements. Item B may include a single element or multiple elements. Item C may include a single element or multiple elements.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

Example 1 is a universal serial bus (USB) connector assembly comprising: a connector housing configured to mate with a corresponding connector receptacle; a first cable bundle disposed partially within the connector housing, the first cable bundle including power wires; a second cable bundle disposed partially within the connector housing, the second cable bundle including differential data transmission wires; and a USB connector disposed partially within the connector housing.

In Example 2, the subject matter of Example 1 includes a first seal disposed around the USB connector, the first seal configured to contact a corresponding sealing surface within the corresponding connector receptacle; and a seal retainer disposed partially within the connector housing, the seal retainer to secure the first seal within the connector housing.

In Example 3, the subject matter of Examples 1-2 includes a second seal disposed within the corresponding connector receptacle; and a sealed rear strain relief connected to the connector housing, the sealed rear strain relief including a retaining surface to contact the second seal and cause the second seal to be retained within the connector housing.

In Example 4, the subject matter of Example 3 includes wherein the sealed rear strain relief is threaded onto the first cable bundle and the second cable bundle.

In Example 5, the subject matter of Examples 3-4 includes wherein the sealed rear strain relief reduces or prevents the first cable bundle and the second cable bundle from being removed from the connector housing.

In Example 6, the subject matter of Examples 1-5 includes a connector position assurance latch disposed on the connector housing, the connector position assurance latch including a latching portion configured to engage with a latch receptacle on the corresponding connector receptacle to prevent disconnection of the connector housing from the corresponding connector receptacle.

In Example 7, the subject matter of Example 6 includes wherein the connector position assurance latch is configured to slide toward the USB connector to engage with the latch receptacle on the corresponding connector receptacle.

In Example 8, the subject matter of Examples 1-7 includes wherein the connector housing provides a friction fit with the corresponding connector receptacle, the friction fit to prevent disconnection of the connector housing from the corresponding connector receptacle.

In Example 9, the subject matter of Examples 1-8 includes wherein the differential data transmission wires are configured for USB 3.x or USB 4 communication.

In Example 10, the subject matter of Examples 1-9 includes a paddle card disposed within the connector housing, the paddle card coupled between the USB connector and the first cable bundle and the second cable bundle.

In Example 11, the subject matter of Example 10 includes wherein the first cable bundle and the second cable bundle are routed to and soldered to corresponding cable solder pads on the paddle card.

In Example 12, the subject matter of Examples 10-11 includes wherein the second cable bundle includes a shielded cable jacket, the shielded cable jacket to provide radio frequency (RF) shielding for the differential data transmission wires.

In Example 13, the subject matter of Example 12 includes wherein the shielded cable jacket is surrounded by an external cable sheath.

In Example 14, the subject matter of Examples 12-13 includes the shielded cable jacket configured to provide RF shielding and mechanical stability.

In Example 15, the subject matter of Examples 12-14 includes wherein: the shielded cable jacket is conductively coupled to a first ground contact on the paddle card; the USB connector is conductively coupled to a second ground contact on the paddle card; and the first ground contact is conductively coupled to the second ground contact.

In Example 16, the subject matter of Examples 13-15 includes wherein the shielded cable jacket is configured to provide be clamped within the connector housing to retain the first cable bundle and the second cable bundle in a fixed position within the connector housing.

In Example 17, the subject matter of Examples 1-16 includes an RF shield disposed partially around the USB connector, the RF shield configured to provide RF shielding for the USB connector and retain the first cable bundle and the second cable bundle.

In Example 18, the subject matter of Example 17 includes a first lancing feature formed on a first surface of the RF shield, the first lancing feature configured to deflect temporarily during insertion and then return to a non-coplanar position to engage with a first inner latching surface within the connector housing.

In Example 19, the subject matter of Example 18 includes a second lancing feature, the second lancing feature formed on a second surface of the RF shield, the second surface of the RF shield opposite from the first surface of the RF shield.

In Example 20, the subject matter of Examples 18-19 includes a release tool slot within the connector housing, the release tool slot configured to provide access for a release tool to deflect the first lancing feature.

In Example 21, the subject matter of Examples 17-20 includes a detent formed on an outer surface of the USB connector assembly, the detent configured to prevent over-insertion of the USB connector assembly into the connector housing.

In Example 22, the subject matter of Examples 17-21 includes the USB connector assembly further including a dual wing crimp, the dual wing crimp including a plurality of retention wings configured to be crimped onto the first cable bundle and the second cable bundle.

In Example 23, the subject matter of Example 22 includes the dual wing crimp further including a plurality of retention tabs; wherein: the plurality of retention wings are configured to be crimped onto a first side of first cable bundle and a first side of the second cable bundle; and the plurality of retention tabs are configured to be crimped onto a second side of first cable bundle and a second side of the second cable bundle, the second side of first cable bundle opposite from the first side of first cable bundle, the second side of second cable bundle opposite from the first side of second cable bundle.

In Example 24, the subject matter of Example 23 includes wherein the plurality of retention tabs is formed using an I-shaped cutout of the dual wing crimp.

Example 25 is a method of forming a universal serial bus (USB) connector comprising: providing a connector housing configured to mate with a corresponding connector receptacle; disposing a first cable bundle partially within the connector housing, the first cable bundle including power wires; disposing a second cable bundle partially within the connector housing, the second cable bundle including differential data transmission wires; and disposing a USB connector partially within the connector housing.

In Example 26, the subject matter of Example 25 includes disposing a first seal around the USB connector, the first seal configured to contact a corresponding sealing surface within the corresponding connector receptacle; and disposing a seal retainer partially within the connector housing to secure the first seal within the connector housing.

In Example 27, the subject matter of Examples 25-26 includes disposing a second seal within the corresponding connector receptacle; and connecting a sealed rear strain relief to the connector housing, the sealed rear strain relief including a retaining surface to contact the second seal and cause the second seal to be retained within the connector housing.

In Example 28, the subject matter of Example 27 includes threading the sealed rear strain relief onto the first cable bundle and the second cable bundle.

In Example 29, the subject matter of Examples 27-28 includes wherein the sealed rear strain relief prevents the first cable bundle and the second cable bundle from being removed from the connector housing.

In Example 30, the subject matter of Examples 25-29 includes disposing a connector position assurance latch on the connector housing, the connector position assurance latch including a latching portion configured to engage with a latch receptacle on the corresponding connector receptacle to prevent disconnection of the connector housing from the corresponding connector receptacle.

In Example 31, the subject matter of Example 30 includes sliding the connector position assurance latch toward the USB connector to engage with the latch receptacle on the corresponding connector receptacle.

In Example 32, the subject matter of Examples 25-31 includes wherein the connector housing and the corresponding connector receptacle provide a friction fit to prevent disconnection of the connector housing from the corresponding connector receptacle.

In Example 33, the subject matter of Examples 25-32 includes wherein the differential data transmission wires are configured for at least one of USB 3.x or USB 4 communication.

In Example 34, the subject matter of Examples 25-33 includes disposing a paddle card within the connector housing, the paddle card coupled between the USB connector and the first cable bundle and the second cable bundle.

In Example 35, the subject matter of Example 34 includes soldering the first cable bundle and the second cable bundle to corresponding cable solder pads on the paddle card.

In Example 36, the subject matter of Examples 34-35 includes providing a shielded cable jacket for the second cable bundle, the shielded cable jacket to provide radio frequency (RF) shielding for the differential data transmission wires.

In Example 37, the subject matter of Example 36 includes surrounding the shielded cable jacket with an external cable sheath.

In Example 38, the subject matter of Examples 36-37 includes wherein the shielded cable jacket provides RF shielding and mechanical stability.

In Example 39, the subject matter of Examples 36-38 includes conductively coupling the shielded cable jacket to a first ground contact on the paddle card; conductively coupling the USB connector to a second ground contact on the paddle card; and conductively coupling the first ground contact to the second ground contact.

In Example 40, the subject matter of Examples 37-39 includes clamping the shielded cable jacket within the connector housing to retain the first cable bundle and the second cable bundle in a fixed position within the connector housing.

In Example 41, the subject matter of Examples 25-40 includes disposing an RF shield partially around the USB connector, the RF shield configured to provide RF shielding for the USB connector and retain the first cable bundle and the second cable bundle.

In Example 42, the subject matter of Example 41 includes forming a first lancing feature on an outer surface of the RF shield, the first lancing feature configured to deflect temporarily during insertion and then return to a non-coplanar position to engage with a first inner latching surface within the connector housing.

In Example 43, the subject matter of Example 42 includes forming a second lancing feature on a second surface of the RF shield, the second surface of the RF shield opposite from the first surface of the RF shield.

In Example 44, the subject matter of Examples 42-43 includes forming a release tool slot within the connector housing, the release tool slot configured to provide access for a release tool to deflect the first lancing feature.

In Example 45, the subject matter of Examples 41-44 includes forming a detent as a raised portion on an outer surface of the USB connector assembly, the detent configured to prevent over-insertion of the USB connector assembly into the connector housing.

In Example 46, the subject matter of Examples 41-45 includes forming a dual wing crimp, the dual wing crimp including a plurality of retention wings configured to be crimped onto the first cable bundle and the second cable bundle.

In Example 47, the subject matter of Example 46 includes wherein: the dual wing crimp further includes a plurality of retention tabs; the plurality of retention wings are configured to be crimped onto a first side of first cable bundle and a first side of the second cable bundle; and the plurality of retention tabs are configured to be crimped onto a second side of first cable bundle and a second side of the second cable bundle, the second side of first cable bundle opposite from the first side of first cable bundle, the second side of second cable bundle opposite from the first side of second cable bundle.

In Example 48, the subject matter of Example 47 includes forming the plurality of retention tabs is formed using an I-shaped cutout of the dual wing crimp.

In Example 49, the subject matter of Examples 36-48 includes conductively coupling the shielded cable jacket to a first ground contact located on the paddle card; and conductively coupling the USB connector to a second ground contact on the paddle card.

Example 50 is at least one machine-readable medium including instructions that, when executed by processing circuitry, cause the processing circuitry to perform operations to implement of any of Examples 1-49.

Example 51 is an apparatus comprising means to implement of any of Examples 1-49.

Example 52 is a system to implement of any of Examples 1-49.

Example 53 is a method to implement of any of Examples 1-49.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, a list of items joined by the term “at least one of” may mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A may include a single element or multiple elements.

Item B may include a single element or multiple elements. Item C may include a single element or multiple elements.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A universal serial bus (USB) connector assembly comprising:
a connector housing configured to mate with a corresponding connector receptacle;
a USB connector disposed partially within the connector housing; and
a first seal disposed around the USB connector, the first seal configured to contact a corresponding sealing surface within the corresponding connector receptacle.

2. The USB connector assembly of claim 1, further comprising:
a seal retainer disposed partially within the connector housing, the seal retainer configured to secure the first seal within the connector housing.

3. The USB connector assembly of claim 1, further comprising:
a second seal disposed within the corresponding connector receptacle; and
a sealed rear strain relief connected to the connector housing, the sealed rear strain relief including a retaining surface to contact the second seal and cause the second seal to be retained within the connector housing.

4. The USB connector assembly of claim 1, further comprising:
a connector position assurance latch disposed on the connector housing, the connector position assurance latch including a latching portion configured to engage with a latch receptacle on the corresponding connector receptacle to prevent disconnection of the connector housing from the corresponding connector receptacle.

5. The USB connector assembly of claim 4, wherein the connector position assurance latch is configured to slide toward the USB connector to engage with the latch receptacle on the corresponding connector receptacle.

6. The USB connector assembly of claim 1, wherein the connector housing provides a friction fit with the corresponding connector receptacle to prevent disconnection of the connector housing from the corresponding connector receptacle.

7. The USB connector assembly of claim 1, further comprising:
a first cable bundle disposed partially within the connector housing, the first cable bundle including power wires; and
a second cable bundle disposed partially within the connector housing, the second cable bundle including differential data transmission wires.

8. The USB connector assembly of claim 7, further comprising:
a paddle card disposed within the connector housing, wherein the paddle card is coupled between the USB connector and the first cable bundle and the second cable bundle; and
the first cable bundle and the second cable bundle are routed to and soldered to corresponding cable solder pads on the paddle card.

9. The USB connector assembly of claim 7, wherein the second cable bundle includes a shielded cable jacket configured to provide radio frequency (RF) shielding for the differential data transmission wires.

10. The USB connector assembly of claim 9, wherein the shielded cable jacket is surrounded by an external cable sheath.

11. The USB connector assembly of claim 9, wherein the shielded cable jacket is configured to provide mechanical stability.

12. The USB connector assembly of claim 9, wherein
the shielded cable jacket is conductively coupled to a first ground contact on the paddle card;
the USB connector is conductively coupled to a second ground contact on the paddle card; and
the first ground contact is conductively coupled to the second ground contact.

13. The USB connector assembly of claim 10, wherein the shielded cable jacket is configured to be clamped within the connector housing to retain the second cable bundle in a fixed position within the connector housing.

14. The USB connector assembly of claim 1, further comprising:
a radio frequency (RF) shield disposed partially around the USB connector to provide RF shielding for the USB connector and to retain the first cable bundle and the second cable bundle.

15. The USB connector assembly of claim 14, further comprising:
a first lancing feature formed on a first surface of the USB connector assembly, the first lancing feature configured to deflect temporarily during insertion and then return to a non-coplanar position to engage with a first inner latching surface within the connector housing.

16. The USB connector assembly of claim 15, further comprising:
a second lancing feature, the second lancing feature formed on a second surface of the USB connector assembly, the second surface of the USB connector assembly opposite from the first surface of the USB connector assembly.

17. The USB connector assembly of claim 15, further comprising:
a release tool slot within the connector housing, the release tool slot configured to provide access for a release tool to deflect the first lancing feature.

18. The USB connector assembly of claim 14, further comprising:
a detent formed on an outer surface of the USB connector assembly, the detent configured to prevent over-insertion of the USB connector assembly into the connector housing.

19. The USB connector assembly of claim 14, further comprising:
a dual wing crimp, the dual wing crimp comprising a plurality of retention wings configured to be crimped onto a first cable bundle and a second cable bundle.

20. The USB connector assembly of claim 19, wherein
the dual wing crimp further comprises a plurality of retention tabs;
the plurality of retention wings is configured to be crimped onto a first side of the first cable bundle and a first side of the second cable bundle;
the plurality of retention tabs is configured to be crimped onto a second side of first cable bundle and a second side of the second cable bundle, the second side of first cable bundle being opposite from the first side of first cable bundle and the second side of second cable bundle being opposite from the first side of second cable bundle; and
the plurality of retention tabs is formed using an I-shaped cutout of the dual wing crimp.
